(19) United States
(12) Patent Application Publication
(10) Pub. No.: US 2003/0213546 A1
(43) Pub. Date: Nov. 20, 2003

(54) Extensible nonwoven fabric

(76) Inventor: Herbert Hartgrove, Angier, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/384,330

(22) Filed: Mar. 7, 2003

Related U.S. Application Data
(60) Provisional application No. 60/363,183, filed on Mar. 11, 2002.

(51) Int. Cl. B32B 31/00

(52) U.S. Cl. 156/148; 156/181

(57) ABSTRACT

The present invention relates to a nonwoven fabric, and more specifically, to a durable extensible nonwoven fabric comprising a hydroentangled fibrous blend of non-activated fusible fibers and non-fusible fibers, wherein said nonwoven fabric is subjected to compaction at an elevated temperature thereby activating said fusible fibers to bond with the surrounding fibrous composition and rendering said nonwoven fabric suitable for use in medical applications, such as stockings and wraps.

### TECHNICAL FIELD

The present invention relates to a nonwoven fabric, and more specifically, to a durable, extensible nonwoven fabric comprising a fibrous blend of non-activated fusible fibers and a non-fusible fibers, wherein said fibrous blend is hydroentangled and subsequently subjected to compaction at an elevated temperature to activate said fusible fiber component, thus forming a nonwoven fabric exhibiting recoverable extensibility.

### BACKGROUND OF THE INVENTION

Nonwoven fabrics are used in a wide variety of applications where the engineered qualities of the fabric can be advantageously employed. Nonwoven fabrics are those fabrics consisting of fibrous materials, such as synthetic or natural fibers or combinations thereof. These fibers are then coalesced to form a web, which can then be further treated chemically, mechanically, or in combination, so as to achieve a nonwoven fabric with the desired physical properties.

Mechanically treating nonwoven fabrics with a compressive technology is known in the art. Various compressive methods include compacting, calendering, creping, compressive shrinkage, and use of so called stuffer boxes. Compressive techniques involve overfeeding fabric into a defined space, and steadily releasing the fabric from the defined space so as to enhance the physical characteristics of the fabric.

Applying a post-compressive treatment to a fabric, such as a nonwoven, enhances the fabric's aesthetic and performance qualities, providing the fabric with an improved hand, drape, and extensibility. Compressing a nonwoven fabric in a regulatory manner displaces the fabric in the z-dimension thereby imparting crenulations into the of the machine direction of an otherwise substantially planar fabric. The resulting compacted fabric exhibits some extensibility due to the compressive treatment. The treated nonwoven fabric can then be set by means of heat and pressure in order to retain the acquired properties of the fabric imparted by the post mechanical treatment.

The mechanical post treatment of compaction has been previously applied to nonwoven fabrics, and more specifically, to hydroentangled nonwoven fabrics so as to enhance the absorptiveness or pliability of a nonwoven fabric, however, the prior art fails to recognize the need for a fabric with durable extensibility. The present invention discloses a nonwoven fabric that exhibits the ability to retain its extensible properties subsequent to at least 20 home washings.

The object of the present invention is to provide a durable and extensible nonwoven fabric derived from a hydroentangled fibrous blend comprised of non-activated fusible fibers, wherein the resulting nonwoven fabric is suitable for use in medical applications, such as stockings and wraps.

### SUMMARY OF THE INVENTION

The present invention relates to a nonwoven fabric, and more specifically, to a durable extensible nonwoven fabric comprising a hydroentangled fibrous blend of non-activated fusible fibers and non-fusible fibers, wherein said nonwoven fabric is subjected to compaction at an elevated temperature thereby activating said fusible fibers to bond with the surrounding fibrous composition and rendering said nonwoven fabric suitable for use in medical applications, such as stockings and wraps.

The nonwoven fabric of the present invention is a hydroentangled fibrous blend comprising fusible fibers. Once hydroentangled, the fabric is dried, but at a drying temperature less than that of the activation temperature of the fusible fiber. The nonwoven fabric may be subsequently wound, or in the alternative, directly fed into a compacting apparatus, wherein the hydroentangled fabric is subject to compaction at a temperature that activates the fusible fiber to bond with the surrounding fiber. The resulting nonwoven fabric exhibits durable extensibility and is capable of retaining the imparted extensible performance after at least 20 home washes. Prior to compaction, the fabric is optionally coated with a latex binder so as to impart durable recovery properties to the fabric.

The resulting nonwoven fabric of the present invention is suitable for use as a hospital issued or commercially available wrap or stocking utilized to reduce the potential for swelling about an injury site. The wrap or stocking is placed in contact with the skin so as to apply a controlled compressive force to the injury site. After or during the course of use, the wrap or stocking may be laundered, while exhibiting the ability to retain the recoverable extensibility performance of the nonwoven fabric.

### BRIEF DESCRIPTION OF THE DRAWINGS

FIG. 1 is a diagrammatic view of the apparatus for the fabrication of the nonwoven fabric according to the present invention.

### DETAILED DESCRIPTION OF THE INVENTION

While the present invention is susceptible of embodiment in various forms, hereinafter is described presently preferred embodiments of the invention, with the understanding that the present disclosure is to be considered as exemplifications of the invention, and is not intended to limit the invention to the specific embodiments illustrated.

The fibrous blend of the present invention is comprised of a non-activated fusible fiber as well as a non-fusible fiber. The non-fusible fiber may be that of a synthetic or natural fiber, or a combination thereof. Synthetic fibers of the present invention may be utilized at a preferred range of 80%-95% by weight, and a most preferred range of 88%-92% by weight, wherein the synthetic fibers may be selected from thermoset polymers such as polyacrylates, or from thermoplastic polymers, including polyamides, polyesters, polyolefins, their derivatives and combinations thereof. Natural fibers of the present invention are cellulosic in nature such as cotton, wood pulp, or rayon.

In accordance with the present invention, at least a portion of the fibrous nonwoven web consists of thermally fusible fibers, also called binder fibers or bi-component fibers, that are activated through the application of heat and pressure that follow the compaction process. Fusible fibers are those fibers that comprise at least two polymer types. Suitable fusible fibers that can be utilized in the present invention include configurations such as side-by-side or sheath-core, as well as other geometric variations, wherein the fusible fiber may be employed at a preferred range of 5%-20% by weight, and a most preferred range of 8%-12% by weight.

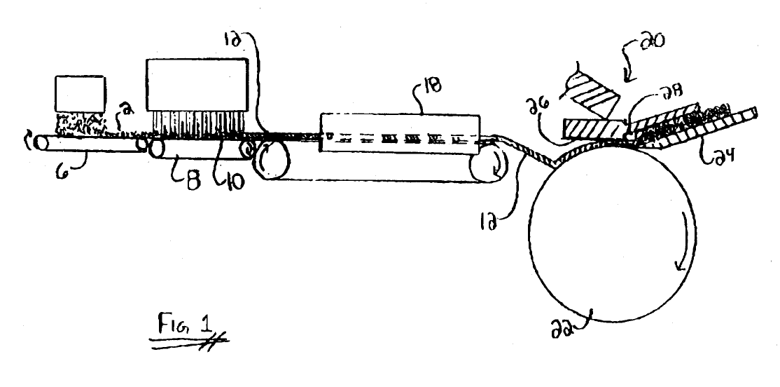

In reference to FIG. 1, therein is illustrated an apparatus for practicing the method of the present invention for forming a nonwoven fabric. The nonwoven fabric is produced by a process known as hydroentanglement. In this process, a web of loose fibers 2 is produced by a series of cards or by other known equipment that is capable of producing an unbonded web of fibers, and deposited on conveyor 6. Web 2 is then supported on a perforated surface 8 and is subjected to treatment with a large number of fine water jets 10, causing fiber web 2 to rearrange and become entangled into a coherent, durable, nonwoven web 12. The apertured pattern in the support surface can be varied to provide a variety of apertured and non-apertured patterns. The now coherent web is transported to another conveyor 14 and passed through drier 18 for drying. The process of hydroentanglement is described in more detail in U.S. Pat. No. 3,485,706. to Evans, incorporated herein by reference.

Subsequent to the hydroentangling process, the nonwoven fabric may be wound and then fed into a compaction apparatus or directly fed into a compaction apparatus, such as a microcreper. The particular microcreping process employed was that as is commercially available from the Micrex Corporation of Walpole, Mass., and is referred to by the registered mark of the same company as “MICREX”. The apparatus for performing MICREXING is described in U.S. Pat. No. 3,260,778; No. 3,416,192; No. 3,810,280, No. 4,090,385; and No. 4,717,329, hereby incorporated by reference, during the microcreping process the fabric is conveyed between roll 22 and blade 24 conversing toward the roll. The nonwoven web 12 is conveyed into a defined space 26, firmly gripped and conveyed into a main treatment cavity 28 where microcreping or compacting takes place.

As a critical part of the method of the invention, the nonwoven fabric is exposed to pressure and heated to a temperature that activates the fusible fibers to form bonds with the surrounding fibrous composition. The fabric is exposed to the heat and pressure during the microcreping process in order to permanently retain the acquired crepe upon cooling. Conveniently, this may be accomplished by heating roll 22 in the creping apparatus upon which the fabric is supported.

In a first preferred embodiment, a nonwoven fabric comprised of a 10% fusible fiber supplied by KoSa, commercially known as T252 and 90% polyester supplied by Wellman, commercially known as T472, was fed into a microcreping apparatus, which was operated at a batcher speed of 30 yards per minute. Compression of 70 psi was utilized, with a roll temperature of 350° Fahrenheit. The resultant nonwoven fabric was compacted at 25%. The nonwoven fabric of the present invention has a preferred compaction range from about 10%-40% and a most preferred compaction range form about 15%-25%.

In a second preferred embodiment of the invention, the nonwoven web is coated with a latex binder prior to compaction in order to impart a durable, extensible nonwoven fabric with recovery properties. The latex binder can be coated onto the fabric using conventional application techniques, such as dipping, spraying, or printing. The dipping process is performed by running the web through a binder filled tank or pan, then removing the excess binder with squeeze rolls. The binder may be sprayed onto the web as well, coating one side or both sides. Spray guns operated by pressurized air or hydraulic jets operated by hydraulic pressure, apply the binder onto the web in the form of tiny droplets. The latex binder can also be printed onto the nonwoven web. By using a patterned roller, the binder can be applied to selected areas of the web or applied to the entire nonwoven web.

It is within the purview of the invention that the nonwoven fabric may be a composite, laminate, single layer or multiple layers in order to incorporate support and/or absorbent mechanisms into the fabric. The nonwoven may be imaged and/or apertured, or modified aesthetically through subsequent dyeing, and printing, or by using colored fibers during the manufacturing step, to achieve the affects of the desired end use application. The nonwoven fabric has a preferred basis weight range of 1.5-8.0 ounces per square yard, with a range of 3.0-5.0 ounces per square yard being most preferred.

The resulting hydroentangled and compacted nonwoven fabric exhibits a durable extensibility wherein the fabric is capable of retaining its extensibility subsequent to at least 20 wash cycles. Table 1 illustrates the stretch and recovery performance of the present invention after 5, 10, 15, and 20, wash cycles. A wash cycle refers to a complete cycle consisting of wash-spin-rinse-spin and is conducted by use of a heavy-duty automatic washer.

A number of end-use articles can be benefit from the durable, extensible nonwoven fabric of the present invention, including, but not limited to, a primary or secondary medical wrap or compression stocking. Further, the disclosed nonwoven fabric is suitable for mattress pad covers, wherein the skirt of the mattress pad cover must exhibit extensibility so as to expand over the thickness of the mattress on which the cover is fitted. The nonwoven fabric of the present invention may also be utilized as elastic waistband material in bottom weights for men or women, such as pants or shorts.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

TABLE 1

| No. of Wash Cycles | Bulk (mils) | Stretch (%) | Recovery |
|---|---|---|---|
| 5 | 0.032 | 13 | 98 |
| 10 | 0.036 | 15 | 97 |
| 15 | 0.041 | 15 | 97 |
| 20 | 0.041 | 17 | 99 |

What is claimed is:

1. A method of making an extensible nonwoven fabric comprising the steps of:
a. providing a fibrous web comprising a blend of non-activated fusible fibers and non-fusible fibers;
b. applying hydraulic energy to said fibrous batt through a plurality of hydraulic manifolds to form a nonwoven fabric;
c. compacting said nonwoven fabric;
d. applying heat and pressure during compaction process to said nonwoven fabric so as to activate the fusible fibers to bond with the surrounding fibrous composition.

2. A method of making an extensible nonwoven fabric as in claim 1, wherein said nonwoven fabric is wound before being compacted.

3. A method of making an extensible nonwoven fabric as in claim 1, wherein said nonwoven fabric is at least 15% compacted.

4. A method of making an extensible nonwoven fabric as in claim 1, wherein said fibrous web is comprised of a blend of staple length non-activated fusible fibers and staple length natural or synthetic fibers or a combination thereof.

5. A method of making an extensible nonwoven fabric as in claim 4, wherein said natural fibers are selected from the group consisting of cotton, wood pulp, rayon or the combinations thereof.

6. A method of making an extensible nonwoven fabric as in claim 4, wherein said synthetic fibers are selected from the group consisting of polyesters, polyamides, polyolefins, and the combination thereof.

7. A method of making an extensible fabric as in claim 1, wherein said fibrous batt comprises at least 10% non-activated fusible fiber.

8. A method of making an extensible nonwoven fabric as in claim 1, wherein said hydroentangled nonwoven fabric is dried at a temperature less than the activation temperature of the fusible fiber.

9. A method of making an extensible nonwoven fabric comprising the steps of:
a. providing a fibrous web comprising a blend of non-activated fusible fibers and non-fusible fibers;
b. applying hydraulic energy to said fibrous batt through a plurality of hydraulic manifolds to form a nonwoven fabric;
c. coating said nonwoven fabric with a latex binder;
d. compacting said nonwoven fabric;
e. applying heat and pressure during compaction process to said nonwoven fabric so as to activate the fusible fibers to bond with the surrounding fibrous composition.

10. A method of making an extensible nonwoven fabric as in claim 8, wherein said extensible nonwoven fabric comprising said recovery properties exhibits said performance after at least 20 wash cycles.
